(19) United States
(12) Patent Application Publication
(10) Pub. No.: US 2003/0061286 A1
(43) Pub. Date: Mar. 27, 2003

(54) Co-browsing system including form and focal-point synchronization capabilities for both secure and non-secure web documents

(76) Inventor: Jin Kun Lin, Chapel Hill, NC (US)

Correspondence Address: JENKINS & WILSON, PA, 3100 TOWER BLVD, SUITE 1400, DURHAM, NC, 27707, US

(21) Appl. No.: 09/966,682

(22) Filed: Sep. 27, 2001

(51) Int. Cl. G06F 15/16

(52) U.S. Cl. 709/205; 715/501.1; 709/218

(57) ABSTRACT

Described are a system and its methods for extending the web co-browsing functions of both secure and non-secure web pages. The extension includes form synchronization and focal-point synchronization. Focal-point synchronization is accomplished using a shared pointer and page scrolling. To provide these functions for both non-secure and secure web pages without breaking the security models of web browsers, two control applets, one in a non-secure frame and the other in a secure frame, are downloaded to the web browser of a conference participant. The control applets function as control and communication gateways for shared HTTP and HTTPS pages. Form synchronization is accomplished by detecting update events of form elements. Focal-point synchronization is achieved by adding mouse click events to embedded images or hyperlinks in web pages. These events are then decoded by the control applets and sent to a co-browse server. The co-browse server notifies other users' control applets to update the form data, to change the location of the shared pointer, or to scroll the displayed page to a common focal point.

### TECHNICAL FIELD

The present invention generally relates to information processing. More particularly, the present invention is directed to hyper-text markup language (HTML) collaborative document processing.

### BACKGROUND ART

Prior to the popularity of the world wide web, traditional multi-user collaboration systems allowed several participants to join a conference group via multiple peer-to-peer connections to share documents while communicating over an audio communication link, such as a telephone. Each of these conventional systems requires manual installation of special programs on all participants' computers. The installation processes of these programs are complex. Moreover, the programs are not platform-independent. As a result, these programs are not widely used. Examples of such traditional peer-to-peer collaboration systems are Microsoft's NETMEETING™ and WHITEBOARD™.

As the use of the world wide web has increased, several web-based collaboration systems have been developed. Two types of collaboration systems are currently in use. The first type of system uses JAVA® applets to display shared graphic and text information among participants in a web-based conference. A typical implementation is a shared whiteboard on which participants can write, draw, or type. This system is of limited use because participants cannot freely share documents. The other type of system allows conference participants to automatically see the same web pages displayed on their respective web browsers. Such systems are generally referred to as co-browsing systems. Co-browsing systems allow conference participants to collaboratively share web documents, which are usually HTML files, using web browsers. Compared with the traditional collaboration systems, co-browsing systems offer a much higher degree of interoperability, since virtually every desktop system is web-enabled for web browsing. Co-browsing systems also allow the direct sharing of large quantities of web documents.

FIG. 1 illustrates the architecture of a conventional co-browsing system. In FIG. 1, the system includes the web 110, a co-browse server 112, client-side managers 114, and web browsers 116. Web browsers 116 and client-side managers 114 execute on client computers 118. Web browsers 116 function as the display and interaction environment for co-browsing conferences.

The typical documents available on the Internet today are those defined in hyper-text markup language. HTML documents are prepared and/or stored on web server systems and sent to client computer system software (usually referred to as “browsers”) in response to requests. The typical request-and-reply protocol defined for the exchange of this information is called hyper-text transfer protocol (HTTP). For security reasons, HTTP over Secure Sockets Layer (SSL) or HTTPS is also used extensively in the transactions of applications for electronic commerce.

When a user clicks on one of the hyper-links inside a shared HTML document, the request is redirected to co-browse server 112, which broadcasts the new document to all participants. Client-side managers 114 are responsible for directing web browser 116 to display the current shared document. Client-side managers 114 are typically implemented with a single JAVA® applet that can update a shared window from one displayed web document to another, including both secure (HTTPS) and non-secure (HTTP) documents.

The conventional co-browsing implementation illustrated in FIG. 1, while simple and straightforward, lacks features that are critical for collaboration systems, such as form synchronization and focal-point synchronization. Form synchronization refers to the ability to allow conference participants to view an HTML form as it is being filled in or completed in real time by another conference participant. Focal-point synchronization includes synchronizing shared pointers and page scrolling. While a co-browsing system can use a single JAVA® applet to update the shared window from one web file to another, which may be either secure (HTTPS) or non-secure (HTTP), it can neither receive user events from nor update the content in shared web files of both types (secure and non-secure) without breaking the security model of most browsers that prohibit communication between a JAVA® applet and a web file of different security types. In other words, due to the security model of the browsers that forbid JAVA® applets from communicating with web pages of different security types, form and focal-point synchronization can not be implemented on both secure and non-secure web pages simply using a JAVA® applet. For example, a JAVA® applet downloaded using HTTP cannot detect pointed updates or form modifications on shared web pages downloaded using HTTPS. Similarly, a JAVA® applet downloaded using HTTPS cannot detect pointer updates or form modifications in shared web pages downloaded using HTTP. Accordingly, there exists a need for a co-browsing system that allows both form and focal point synchronization on both secure and non-secure documents.

### DISCLOSURE OF THE INVENTION

The present invention includes methods and systems for form and focal point synchronization for both secure and non-secure web documents. In order to achieve this synchronization, a secure and a non-secure control applet execute on each conference participant's computer. The secure control applet establishes a secure connection with a co-browse server, and the non-secure control applet also establishes a secure connection with the co-browse server. Form and focal point synchronization scripts that include callback functions are also downloaded to each participant's computer. The callback functions detect user events, such as a form entry or focal point movement and notify the appropriate secure or non-secure control applet. If the user event occurs in a secure web document, the secure control applet notifies the co-browse server. The co-browse server then broadcasts the event to the secure control applets of other conference participants. If the user event occurs in a non-secure web document, the non-secure control applet notifies the co-browse server. The co-browse server then broadcasts the event to the non-secure control applets of other conference participants.

Because the present invention detects user events and allows form and focal point synchronization for both secure and non-secure web documents, interactive form completion and focal point movements can occur seamlessly.

Accordingly, it is an object of the present invention to provide a mechanism to support the sharing of both secure and non-secure web documents and allow users to collaboratively complete forms, to have a shared pointer, and to scroll to a point of common interest on these documents without breaking the security model of web browsers.

Some of the objects of the invention having been stated hereinabove, other objects will become evident as the description proceeds when taken in connection with the accompanying drawings as best described hereinbelow.

### BRIEF DESCRIPTION OF THE DRAWINGS

Preferred embodiments of the present invention will now be described, by way of example only, with reference to the accompanying drawings in which:

FIG. 1 illustrates a conventional web-based collaboration system architecture;

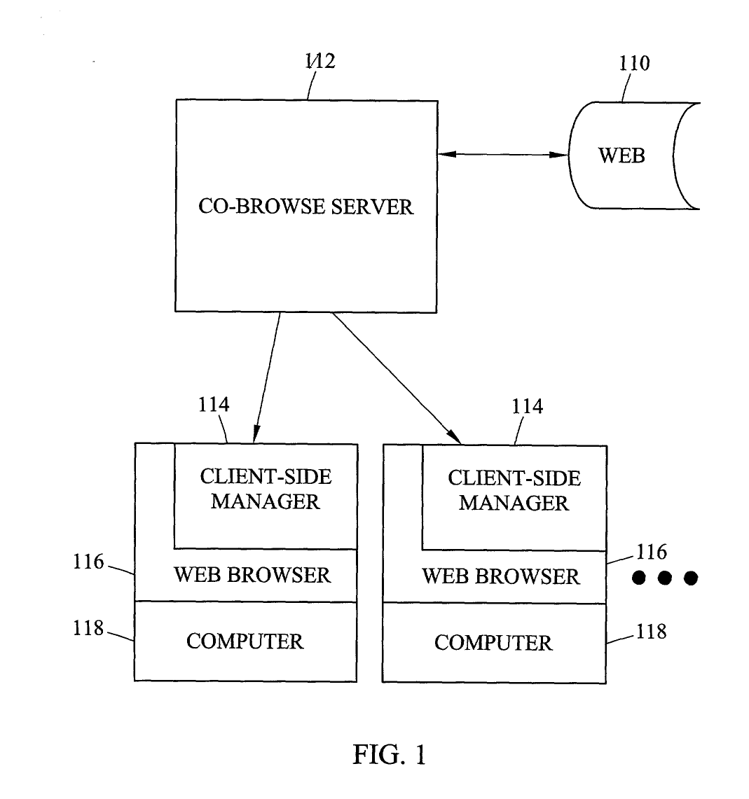

FIG. 2 is a functional block diagram of a co-browsing system according to an embodiment of the present invention;

FIG. 3 is a flow chart showing an exemplary conference creation and joining process according to an embodiment of the present invention;

FIG. 4 is a schematic diagram showing an exemplary user display produced by a co-browsing system according to an embodiment of the present invention;

FIG. 5 is a flow chart showing a process for handling activity in a co-browsing conference according to an embodiment of the present invention;

FIG. 6 is a flow chart illustrating exemplary steps performed by a co-browse server in modifying a web document requested by a conference participant according to an embodiment of the present invention;

FIG. 7 is a flow chart illustrating a process for form synchronization among multiple browser computers according to an embodiment of the present invention; and

FIG. 8 is a flow chart illustrating a process for focal-point synchronization among multiple browser computers according to an embodiment of the present invention.

### DETAILED DESCRIPTION OF THE INVENTION

The present invention is directed to a co-browsing system. One important feature of this co-browsing system is that it supports collaborative user interaction with both secure (HTTPS) and non-secure (HTTP) web pages without additional program installation or security privileges. The collaborative user activity includes form filling, pointer sharing, and page scrolling.

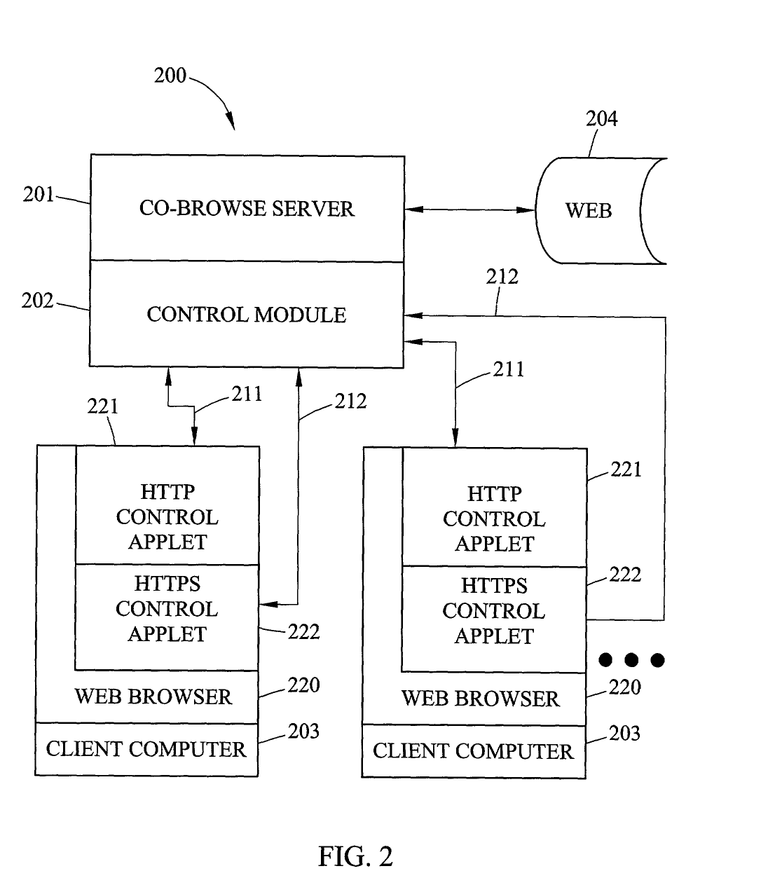

Referring to FIG. 2, a system is shown, generally designated 200, which includes a server computer, hereinafter referred to as a co-browse server 201, which is part of a computer network, such as the world wide web 204. Co-browse server 201 can access the non-secure and secure web pages on the web using the HTTP or HTTPS protocols and the appropriate network, addresses or URLs. Co-browse server 201 includes a control module 202 that enables multiple computers, referred to herein as client computers, to co-browse. In FIG. 2, co-browsing system 200 includes client computers 203. Client computers 203 may be used by participants in a co-browsing session. Each client computer 203 has a web browser 220. Web browsers 220 may be conventional web browsers capable of displaying HTML documents to end users.

According to an important aspect of the invention, two programs are associated with each web browser 220 to facilitate form and focal point synchronization for secure and non-secure web documents. In the illustrated example, the two programs are HTTP control applet 221 and HTTPS control applet 222. Control applets 221 and 222 are preferably platform-independent and capable of interacting with co-browse server 201 when a participant changes a form or moves the focal point. In one example, applets 221 and 222 may be ActiveX controls implemented using ActiveX technology available from Microsoft. ActiveX controls are commonly used to add interactivity, such as pop-up menus, to web pages. According to the present invention, applets 221 and 222 allow form and focal point synchronization for both secure and non-secure web documents. The operation of applets 221 and 222 will be described in detail below.

Both HTTP control applet 221 and HTTPS control applet 222 function as gateways that allow co-browse server 201 to communicate with web browser 220. HTTP control applet 221 allows web browser 220 to communicate with co-browse server 201 when sharing non-secure web pages, and HTTPS control applet 222 allows web browser 220 to communicate with co-browse server 201 when sharing secure web pages. There may be multiple instances of client computers 203 in a co-browsing session. Control applets 221 and 222 make connections 211 and 212 to the control module of co-browse server 201. For security reasons, communication links 211 and 212 are preferably encrypted, for example, using the SSL (Secure Sockets Layer) protocol.

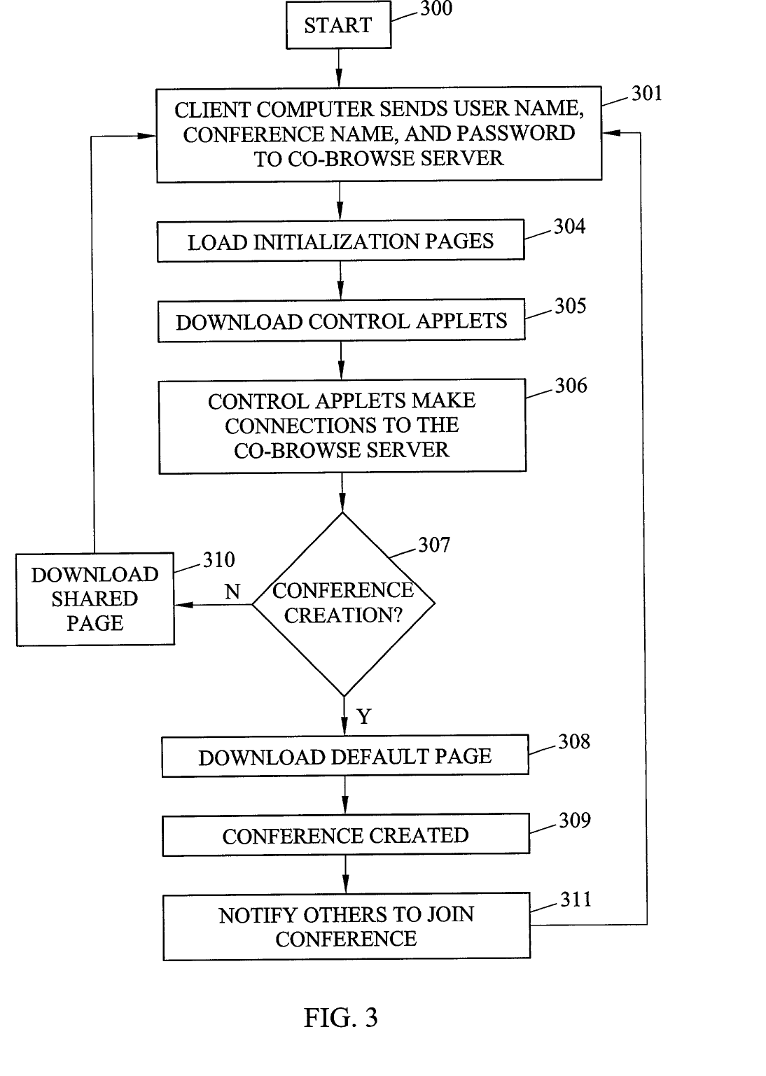

Exemplary steps creating or joining a web co-browsing session according to an embodiment of the present invention are shown in FIG. 3. Referring to FIG. 3, the logic starts at block 300 when the web conference may not exist. In block 301, a client computer 203 logs in by sending user name, conference name, and password to co-browse server 201. After login, client computer 203 receives conference initialization pages from co-browse server 201 (block 304). The initialization pages include two control pages that produce two browser frames. As used herein, the term “frame” refers to a rectangular section of a web page displayed by a web browser that is a separate HTML document from the rest of the page. One of the initialization pages or documents is downloaded using the secure HTTPS protocol and its associated frame is referred to herein as the HTTPS control frame. The other initialization page is downloaded using the non-secure HTTP protocol and is referred to herein as the HTTP control frame. The function of the HTTP and HTTPS control frames will be described in detail below.

Once the HTTP and HTTPS control frames are downloaded, HTTP and HTTPS control applets 221 and 222, are downloaded and embedded in the HTTP and HTTPS control frames as illustrated in block 305. After control applets 221 and 222 are downloaded, control applets 221 and 222 make connections 211 and 212 to co-browse server 201. At decision point 307, co-browse server 201 checks whether client computer 203 wants to create a conference. If co-browse server 201 determines that client computer 203 wants to create a conference, in block 308, co-browse server 201 asks client computer 203 to download and display a default conference page in its co-browsing frame. At this stage, a conference is created, as illustrated in block 309. The user of client computer 203 can notify others to join the co-browse conference, e.g., through email, telephone, or a chat program. If the test in step 307 is false, indicating that the client computer wants to join a conference instead of creating a conference, co-browse server 201 notifies client computer 203 to download and display the shared web page, which is currently being displayed to other conference participants.

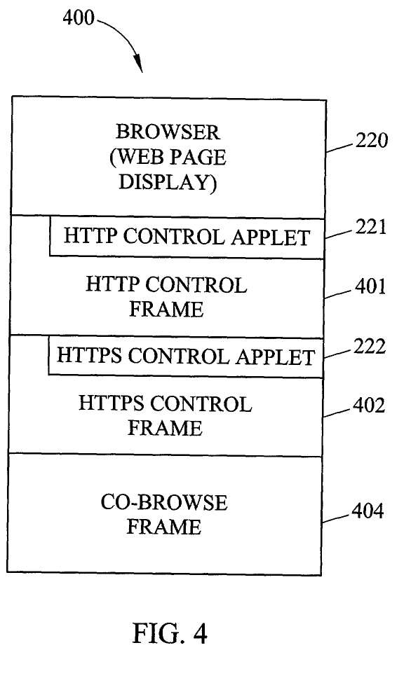

An exemplary display layout of a web browser 220 in a co-browsing conference according to an embodiment of the present invention is shown in FIG. 4. The display format illustrated in FIG. 4 is downloaded from co-browse server 203 as the initialization page (step 304 illustrated in FIG. 3). The browser displays three frames—an HTTP control frame 401, an HTTPS control frame 402, and a co-browsing frame 404. As described above, HTTP control frame 401 contains HTTP control applet 221, and HTTPS control frame 402 contains HTTPS control applet 222. Co-browsing frame 404 presents shared web pages that are viewed by participants in a web conference. HTTP and HTTPS control frames 401 and 402 can be minimized to be invisible to the user.

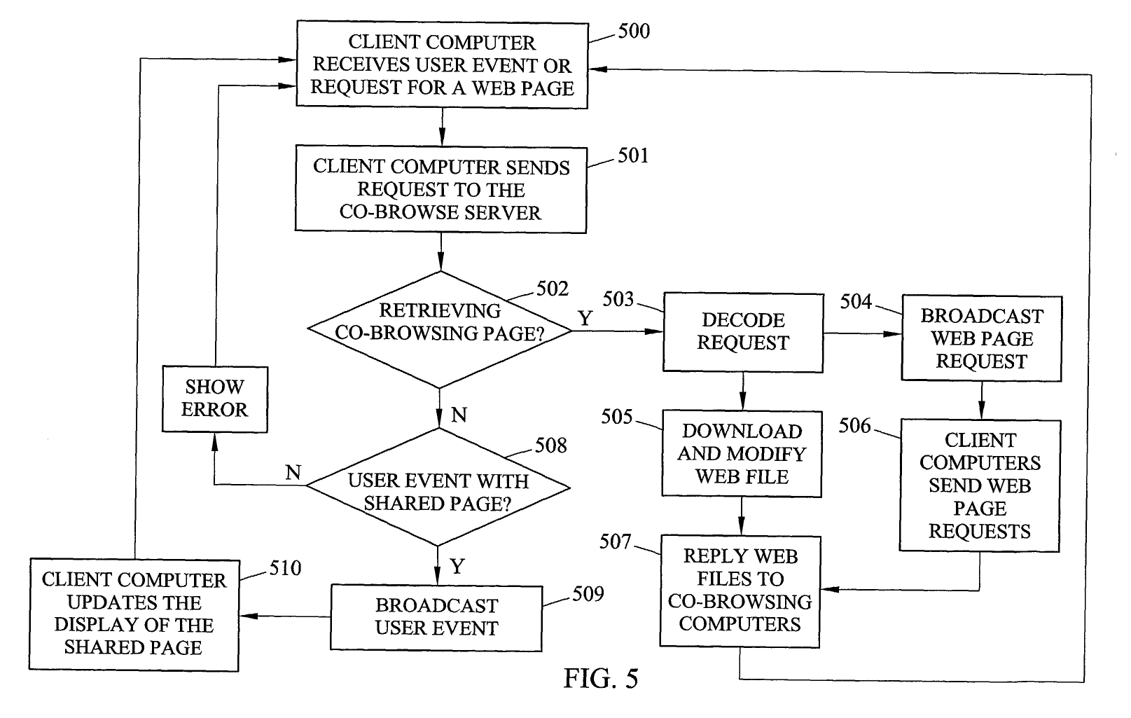

FIG. 5 illustrates an exemplary co-browsing process according to an embodiment of the present invention. While FIG. 5 depicts the co-browsing process in flow chart format for purposes of illustration, some of the processes illustrated in FIG. 5 may execute continuously and in parallel with each other. The cycle of the co-browsing process starts at block 500 when a client computer 203 receives a user event within the shared web page or requests for the retrieval of another shared web page. As used herein, the term “user event” refers to an action taken by the user that is detected by callback functions (described below) executing on client computer 203. A user event within the shared page may occur when the user clicks on an embedded object or the user updates data of a web form. Once a user event occurs, client computer 203, as illustrated in block 501, transmits a request to co-browse server 201 in order to get a new web page or to broadcast the user event to other client computers 203 participating in the conference. If the user event is initiated from a secure HTTPS web page, the request is sent through the HTTPS control applet; otherwise, the request is sent through the HTTP control applet. Because the co-browsing system of the present invention establishes connections between an HTTP control applet and an HTTPS control applet and co-browse server 201 in advance, and is capable of distinguishing between secure and non-secure web pages, co-browsing both secure and non-secure web pages can occur seamlessly.

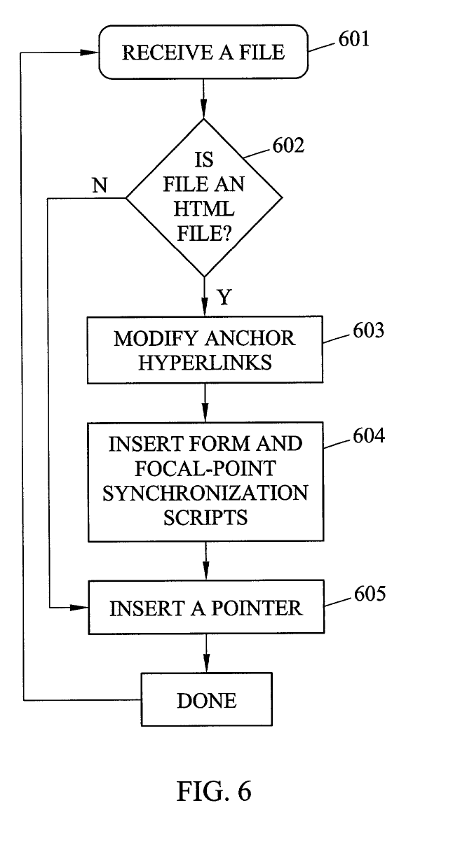

When co-browse server 201 receives the request, it checks, as illustrated in diamond 502, whether the request is for retrieving another web page for co-browsing. If the request is for web page retrieval, co-browse server 201 decodes the request to get the address of the requested web page, the conference name, the user name, and the window name for the page (block 503). Before decoding the request, co-browse server 201 may need to decrypt the request, if the request is transmitted in secure HTTPS protocol. Next, in block 505, co-browse server 201 downloads and modifies the requested web page. The process of modifying the web page will be described below with reference to FIG. 6.

Simultaneously with modifying the web page, co-browse server 201 broadcasts a request to notify other client computers to download and display the web page (blocks 504 and 506). Co-browse server 201 then replicates the modified web page to all client computers in the conference. If the test illustrated by diamond 502 is false, indicating that the request is not for web page retrieval, the request must be a user event within the shared web page. The event is then broadcast to other client computers (block 509) so that they can be used to update the displayed shared page according to the event. The handling of the user events on the shared web page will be described in more detail below.

FIG. 6 illustrates an exemplary process of modifying a co-browsed web file executed in block 505 of FIG. 5. Referring to FIG. 6, after co-browse server 201 receives a requested web file (block 601), co-browse server 201 checks, as illustrated in diamond 602, whether the file is an HTML file. If the file is not an HTML file, the file is not modified and the process is finished. If the file is an html file, co-browse server 201 modifies all hyperlinks (block 603) so that the clicks on these hyperlinks result in sending HTTP or HTTPS requests to co-browse server 202 instead of the original web server. Also, the modified hyperlinks may include the conference identification, the window to update, the user identification, and the original URL. For example, if the web site of co-browse server 202 is “www.PageShare.com,” the original URL (file address) is “http://www.abc.com/news.html,” the conference id is “conf0,” the user id is “1,” and the shared window is “win0,” the modified URL may become: “http://www.PageShare.com/cobrowse?target=/conf0/1/win0/http://www.abc.com/news.html.”

The next step (block 604) of modifying an HTML file is to insert form and the focal-point synchronization scripts, which may be written in JAVASCRIPT®. The form synchronization script registers the update events of all forms' fields and the focal-point script registers the click events of the page's embedded objects, such as images and links. When a participant in a conference updates a form or moves the focal point, the synchronization scripts invoke callback functions to either synchronize web forms or to move the shared pointers and scroll up or down the co-browsed web pages. As will be described below, the gateway between these callback functions of the shared web page and the co-browse server is either HTTP control applet 221 in HTTP control frame 401 or HTTPS control applet 222 in HTTPS control frame 402, depending on whether the shared web page is secure (transmitted via the HTTPS protocol) or non-secure (transmitted by HTTP protocol).

Exemplary pseudo-code for the form synchronization script is as follows:

for each form {

for each field {

form.field.onUpdate = formUpdateNotify( form.id, field.id,
new_value);

}

}

Exemplary pseudo-code for the focal-point synchronization script is as follows:

for each embedded_object {

embedded_object.onClick = focusClickNotify(embedded_object.id);

}

The callback functions, formUpdateNotify and focusClickNotify, may be JAVASCRIPT® callback functions, which execute form and focal-point synchronization. The operation of the functions will be described in more detail below.

The last step (block 605) is to add a shared pointer on the shared page. A graphic image, which is embedded as a layered document, is inserted as the shared pointer. The image, then, can be dynamically moved to be on top of the clicked embedded object. Exemplary computer code for inserting the shared pointer is as follows:

<DIV id=pointer style=POSITION: absolute>

<IMG alt=pointer height=30 src=pointer.gif width=30>

</DIV>

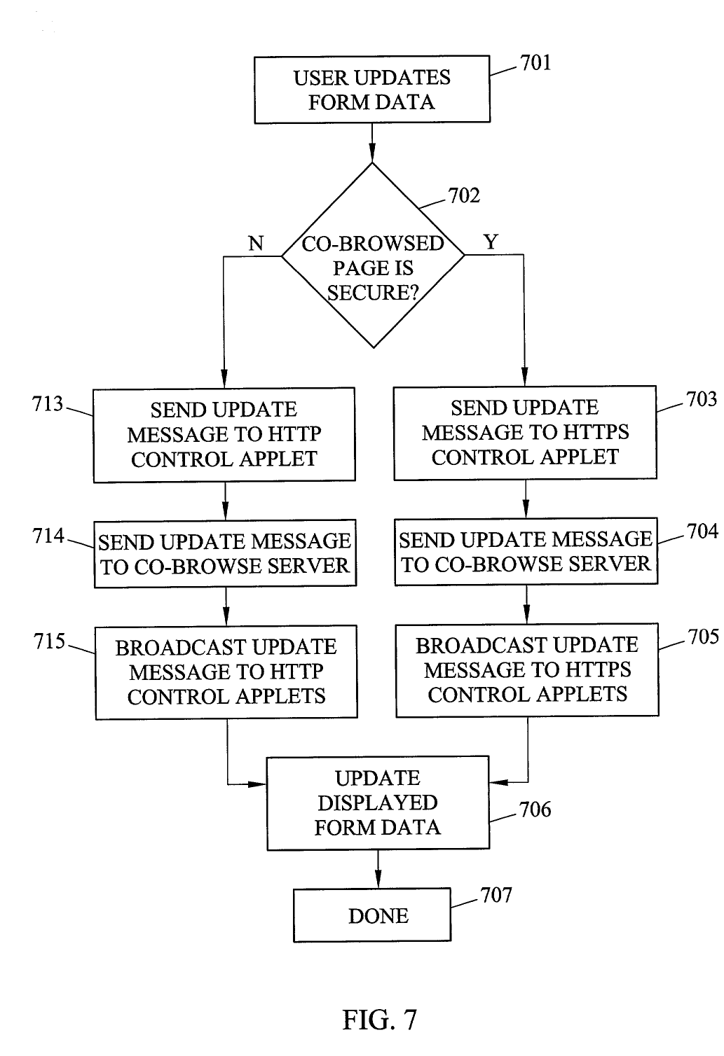

FIG. 7 shows a process for form synchronization among multiple client computers according to an embodiment of the present invention. The process starts at block 701 when a user updates data in a web form. For example, the user may update text in a text form field or select a button in a single or multiple-choice field. Such an update causes the above-illustrated formUpdateNotify callback function to be executed. Next, the process flows to diamond 702, where the callback function checks whether the form is contained in a secure web page. If the form is contained in a secure web page, then an update message is sent to HTTPS control applet 222 in HTTPS control frame 402 as indicated block 703. In block 704, HTTPS control applet 222 sends the update message to co-browse server 201 through connection 212. In block 705 co-browse server 201 broadcasts the update message to HTTPS control applets 222 of all other client computers 203 participating in the conference. In block 706, each HTTPS control applet 222 then updates the displayed form with the received message, which contains form identification, field identification, and the updated value. In block 707, the form update is complete.

If the result of the test indicated by diamond 702 is false, indicating that the web page is non-secure, the process proceeds to blocks 713, 714, and 715. In block 713, since the co-browsed page is non-secure, the formUpdateNotify callback function notifies its local HTTP control applet 221 that !the user is updating a form. In block 714, the HTTP control applet 221 that received the notification forwards the notification to co-browse server 201. In block 715, co-browse server 201 broadcasts the update to the HTTP control applets of other conference participants. The HTTP control applets then display the updated form to their respective users. Because the callback function is capable of distinguishing between form updates in secure and non-secure web pages, form synchronization can seamlessly occur regardless of whether secure or non-secure web pages are being browsed.

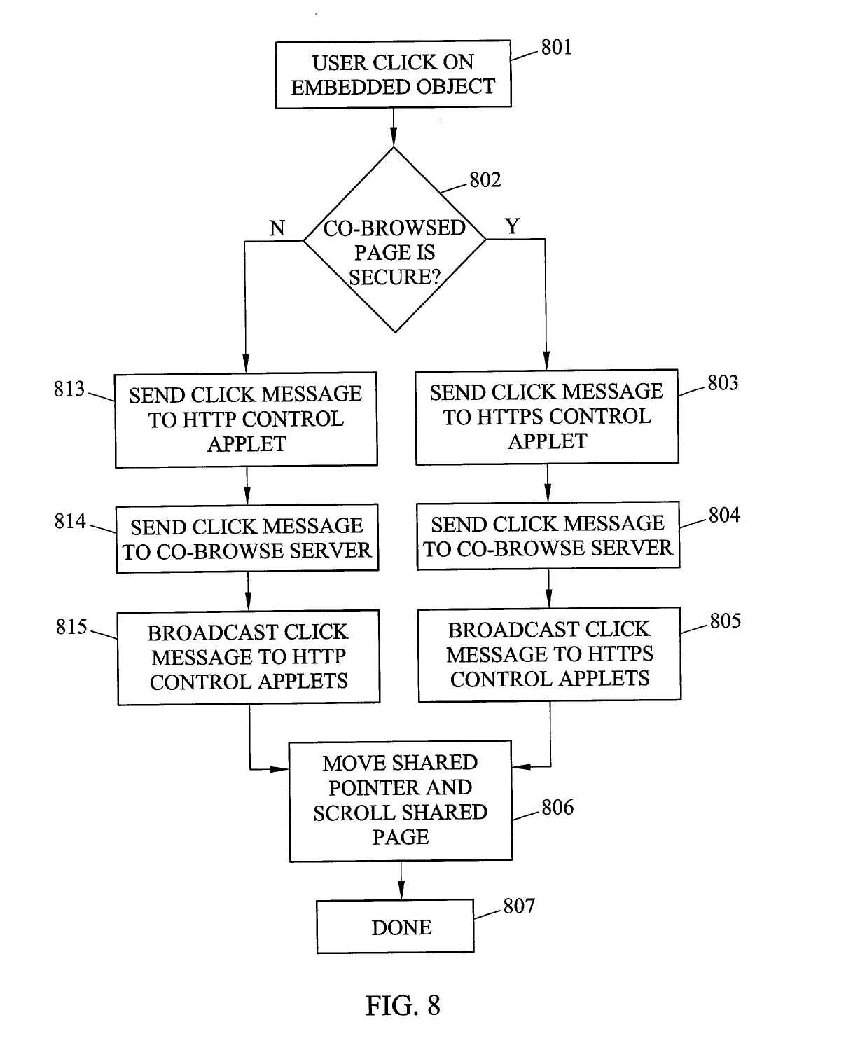

FIG. 8 illustrates a process for pointer synchronization according to an embodiment of the present invention. In FIG. 8, the pointer synchronization process starts at block 801 when a user clicks on an embedded object. When the user clicks on an embedded object, the above described focusClickNotify callback function is executed. The focusClickNotify function determines whether the web page being co-browsed is secure, as indicated by diamond 802. If the web page being browsed is secure, control proceeds to block 803 where the callback function sends a message to HTTPS control applet 222, indicating that the user has clicked on an embedded object within a secure web page. In block 804, HTTPS control applet 222 sends the click message to co-browse server 201. In block 805, co-browse server 201 broadcasts the click message to HTTPS control applets 222 of all client participating in a conference. In block 806, the HTTPS control applets move the shared pointer and scroll the shared web page in accordance with the click action performed by the user.

If the test in diamond 802 indicates that the web page being browsed is non-secure, control proceeds to steps 813, 814, and 815. In block 813, since the co-browsed page is non-secure, the focusClickNotify function sends a notification message to its local HTTP control applet 221 indicating that the user has clicked on an embedded object. In block 814, the HTTP control applet that received the notification forwards the notification to co-browse server 201. In block 815, co-browse server 201 broadcasts the pointer update to the HTTP control applets of other conference participants. The control applets then move the shared pointer and scroll the shared page.

Thus, as illustrated above, the present invention includes form and pointer update synchronization routines that allow users in a co-browsing environment to view data entered into a form by another user and to view click actions by another user without violating a browser's security features. The present invention uses callback functions that notify a co-browse server when a user updates a form or performs a click action. The callback functions determine whether the page being browsed is secure or non-secure and deliver the message to either a secure or non-secure control applet. The control applet delivers the update message to a co-browse server. The co-browse server broadcasts the message to conference participants' appropriate control applets.

It will be understood that various details of the invention may be changed without departing from the scope of the invention. Furthermore, the foregoing description is for the purpose of illustration only, and not for the purpose of limitation—the invention being defined by the claims.

What is claimed is:

1. A system for allowing form and pointer synchronization between users sharing hypertext documents using web browsers, the system comprising:
(a) a secure control applet associated with a web browser on a client computer for sending and receiving form and pointer update information received from a user co-browsing a non-secure web page;
(b) a non-secure control applet associated with the web browser on the client computer for sending and receiving form synchronization and pointer update information received from a user co-browsing a non-secure web page;
(c) at least one callback function for detecting a form modification or a pointer update from a user of the web browser, for determining whether the form modification or pointer update occurs in a secure or non-secure web page, and for sending a form modification or pointer update message to the secure control applet in response to determining that the form modification or pointer update occurs in a secure web page and to the non-secure control applet in response to determining that the form modification or pointer update occurs in a non-secure web page; and
(d) a co-browse server for receiving form modification and pointer update messages from the secure and non-secure control applets and for broadcasting the messages to participants in a co-browsing conference.

2. The system of claim 1 wherein the secure control applet is downloaded using the secure hyper-text transfer protocol (HTTPS).

3. The system of claim 1 wherein the non-secure control applet is downloaded using the non-secure hyper-text transfer protocol (HTTP).

4. The system of claim 1 wherein the callback function includes a first callback function for detecting form modifications and notifying the appropriate secure or non-secure control applet and a second callback function for detecting pointer updates and notifying the appropriate secure or non-secure control applet.

5. The system of claim 1 wherein the co-browse server is adapted to broadcast a form modification or pointer update message to secure control applets of participants in a co-browsing conference in response to receiving the form modification or pointer update from the secure control applet.

6. The system of claim 1 wherein the co-browse server is adapted to broadcast a form modification or pointer update message to non-secure control applets of participants in a co-browsing conference in response to receiving the form modification or pointer update from the non-secure control applet.

7. The system of claim 1 wherein the control applets are adapted to display form modifications and pointer updates to conference participants in response to the messages received from the co-browse server.

8. A method for form modification and pointer synchronization in secure and non-secure web documents among participants in a co-browsing conference, the method comprising:
(a) establishing a web conference that allows multiple participants to simultaneously view web documents;
(b) detecting form modifications and pointer updates by the participants in secure and non-secure web documents;
(c) determining whether the form modifications and pointer updates occur in secure or non-secure web documents;
(d) in response to determining that a form modification or pointer update occurs in a secure web document, notifying a co-browse server via a secure control applet; and
(e) in response to determining that a form modification or pointer update occurs in a non-secure web document, notifying a co-browse server via a non-secure control applet.

9. The method of claim 8 wherein establishing a web conference includes downloading, to each of the participants, a shared web page including form update and pointer synchronization scripts for detecting form updates and pointer actions by the participants and for notifying the co-browse server.

10. The method of claim 8 wherein establishing a web conference includes downloading the secure and non-secure control applets to each of the participants.

11. The method of claim 9 wherein the detecting form modifications and pointer updates includes executing the form update and pointer synchronization scripts.

12. The method of claim 8 wherein notifying a co-browse server via a secure control applet includes notifying the co-browse server via encrypted messages.

13. The method of claim 8 wherein notifying a co-browse server via a secure control applet includes notifying a co-browse server via an HTTP JAVA control applet.

14. The method of claim 8 comprising, at the co-browse server, in response to receiving a form modification or pointer update in a secure web page, broadcasting the form modification or pointer update to the conference participants' secure control applets.

15. The method of claim 8 comprising, at the co-browse server, in response to receiving a form modification or pointer update in a non-secure web page, broadcasting the form modification or pointer update to the conference participants' secure control applets.

16. A computer program product comprising computer-executable instructions embodied in a computer-readable medium for performing steps comprising:
(a) establishing a web conference that allows multiple participants to simultaneously view web documents;
(b) detecting form modifications and pointer updates by the participants in secure and non-secure web documents;
(c) determining whether the form modifications and pointer updates occur in secure or non-secure web documents;
(d) in response to determining that a form modification or pointer update occurs in a secure web document, notifying a co-browse server via a secure control applet; and
(e) in response to determining that a form modification or pointer update occurs in a non-secure web document, notifying a co-browse server via a non-secure control applet.

17. The computer program product of claim 16 wherein establishing a web conference includes downloading, to each of the participants, a shared web page including form update and pointer synchronization scripts for detecting form updates and pointer actions by the participants and for notifying the co-browse server.

18. The computer program product of claim 16 wherein establishing a web conference includes downloading the secure and non-secure control applets to each of the participants.

19. The computer program product of claim 17 wherein the detecting form modifications and pointer updates includes executing the form update and pointer synchronization scripts.

20. The computer program product of claim 16 wherein notifying a co-browse server includes notifying the co-browse server via encrypted messages.

21. The method of claim 16 wherein notifying a co-browse server via a secure control applet includes notifying a co-browse server via an HTTP JAVA control applet.

22. The computer program product of claim 16 comprising, at the co-browse server, in response to receiving a form modification or pointer update in a secure web page, broadcasting the form modification or pointer update to the conference participants via their secure control applets.

23. The computer program product of claim 16 comprising, at the co-browse server, in response to receiving a form modification or pointer update in a non-secure web page, broadcasting the form modification or pointer update to the conference participants via their non-secure control applets.
